(19) United States
(12) Patent Application Publication
(10) Pub. No.: US 2003/0152761 A1
(43) Pub. Date: Aug. 14, 2003

(54) Cushioned household liner

(75) Inventor: Patrice J. McCune, Avon, OH (US)

Correspondence Address: Fay Sharpe Fagan Minnich & McKee LLP, 1100 Superior Avenue, Seventh Floor, Cleveland, OH, 44114-2518, US

(73) Assignee: Manco, Inc., an Ohio Corporation

(21) Appl. No.: 10/071,291

(22) Filed: Feb. 11, 2002

(51) Int. Cl. B32B 3/26

(52) U.S. Cl. 428/319.3; 428/543

(57) ABSTRACT

A sheet material is provided having a smooth continuous top sheet material to which a non-slip foam is directly adhered. The material is created by casting a styrene butadiene material directly on the sheet material without the use of an intermediate layer and curing the material on the film.

### FIELD OF THE INVENTION

This invention relates to sheet material usable by a consumer to protect surfaces and more particularly to a smooth, waterproof, cushioned sheet material with a decorative top surface and a continuous foam bottom surface.

### BACKGROUND OF THE INVENTION

Consumers use a wide variety of sheet materials in and around the home as a lining or underlayment. Typical applications include kitchen shelves, kitchen drawers, dresser drawers, and cabinet drawers. Decorative paper liners have been used for many years. These liners have patterns printed on one side. They are cut to shape by the consumer and placed where desired. Some paper liners include an adhesive backing to hold the liner in place. Plastic sheet materials have also been used in this application.

Foam plastic liners have also been available to consumers. One popular foam plastic liner consists of a loosely woven fabric scrim with a foam polyvinyl chloride coating. This material is non-continuous in that the openings between many of the adjacent scrim fibers remain open after the application of the foam. The foam has non-slip characteristics but is not an adhesive. These products provide cushioning. A variation of this product includes a top layer comprised of a smooth decorated continuous plastic sheet. However, these sheets are not truly flat and smooth in that they are adhering to a bumpy foam coated scrim cushioning layer. Such products are available from a number of sources including Manco, Inc. of Avon, Ohio and are described in patents including Hawley, et al. U.S. Pat. No. 6,130,174 and Hawley, et al. U.S. Pat. No. 6,221,796.

All of these above-described products include some negative aspects. Paper or plastic sheet shelf lining can slide around on a surface and do not provide cushioning. Adhesive paper or plastic shelf liners must be carefully positioned in installation. Some, after being left in place for an extended period of time become difficult to remove cleanly. Vinyl foam coated scrim provides cushioning. However, in some applications plasticizers in the foam can mar a surface or become sticky. The top surface of some products is not flat and smooth but rather bumpy. Moreover, some products sometimes curl rather than laying flat.

A smooth cushioned liner laminate is proposed in U.S. pat. No. 5,854,144 to Hawley. That patent describes a non-slip, non-adhesive liner having a continuous decorative plastic sheet top, a non-woven fibers intermediate sheet and a continuous uniform foam plastic cushioning bottom layer. It is a three component structure. Difficulties in getting the liner to lay flat as opposed to curling at the edges have been encountered.

### SUMMARY OF THE INVENTION

It is the principal object of the present invention to provide a sheet material overcoming the above-referenced negative aspects which is non-slip, non-adhesive, provides a smooth continuous top surface, does not curl, and is inexpensive to manufacture.

It is another object of the present invention to provide a sheet material liner having an upper surface which is pleasing in appearance, colorful and smooth, and a lower surface providing non-slip characteristics which will not mar underlaying surfaces or exude plasticizers.

It is another object of the present invention to provide a shelf liner which is inexpensive to manufacture and which can be easily cut to size and installed by the consumer.

It is yet another object of the present invention to provide a shelf liner which is non-slip, non-adhesive, provides cushioning for the consumer, will not mar underlying surfaces, and is substantially water resistant.

It is yet another object of the present invention to provide a method of manufacturing a shelf liner minimizing manufacturing steps and resulting in a uniform pleasing product.

It is another object of the invention to provide a process of manufacturing a shelf liner which minimizes manufacturing steps and components.

In accordance with the present invention, there is provided a shelf liner product comprised of a thin plastic, continuous sheet material top to which a plastic foam layer is directly adhered.

Further in accordance with the invention, the foam layer provides a non-slip characteristic without the use of adhesives. When lightly placed on a surface, it can be picked up and moved. When pressed down, it will generally not slide laterally.

Still further in accordance with the invention, the foam layer is fabricated without the use of plasticizers.

Yet further in accordance with the invention, a process of manufacturing a shelf liner is provided comprising the steps of printing a plastic top sheet, applying an aqueous dispersion of polymer to the top sheet, and causing the dispersion to foam and cure on the top sheet into a uniform foam layer.

Still further in accordance with the invention, the foam layer and the shelf liner product are resilient, flexible, have a non-slip bottom surface, are not prone to curl and lay flat.

### BRIEF DESCRIPTION OF THE DRAWINGS

The invention may take physical form in certain parts and arrangements of parts. A preferred embodiment of which will be described in detail in the specification and illustrated in the accompanying drawings which form a part hereof and wherein:

FIG. 1 is a side view of the present invention;

FIG. 2 is a side view of the second embodiment of the present invention;

FIG. 3 is a schematic diagram of a method and apparatus for making the embodiments shown in FIGS. 1 and 2;

FIG. 4 is a schematic detail of the curing oven seen in FIG. 3; and,

FIG. 5 shows, schematically, a film 12 as used in the sheet material of FIGS. 1 and 2.

### DESCRIPTION OF THE PREFERRED EMBODIMENTS

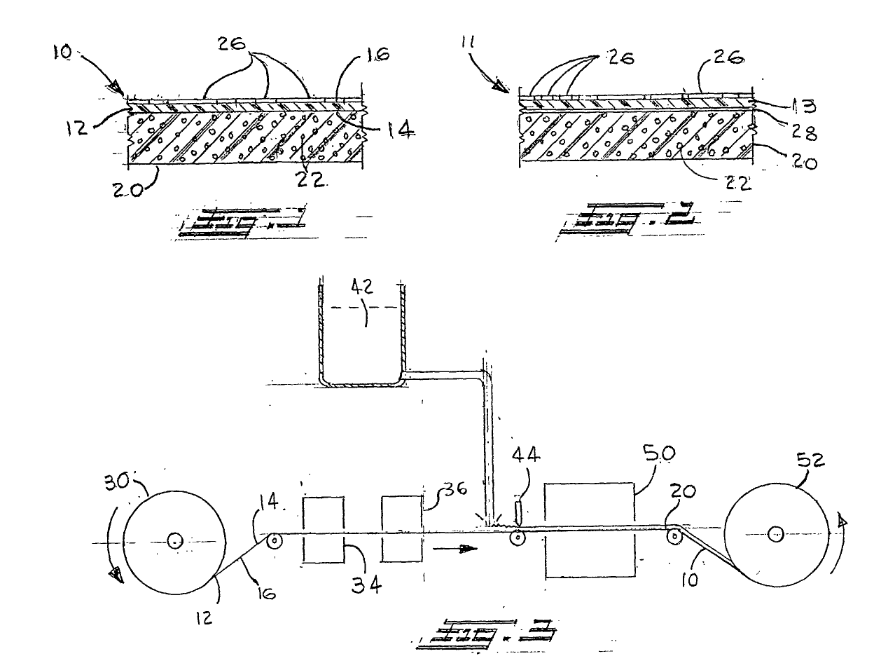

Referring now to the drawings wherein the showings are made for the purposes of illustrating preferred embodiments of the invention only and not for purposes of limiting same, FIG. 1 shows a sheet material 10 suitable for use as a shelf liner or the like. The layers are shown in an exaggerated depth for purposes of film about 3 mils (0.076 millimeters) thick. Preferably the film 12 is a polyolefin film. A polypropylene film 12 is most preferred. A homopolymer polypropylene is preferred by appropriate copolymers may be used. Such polypropylene films are commercially available from a number of sources including Nan Ya Plastics Corp. of Taipei, Taiwan with an affiliate in Lake City, S.C. Moreover, the polypropylene film, and other appropriate films can be specified with skin characteristics. The skin characteristics can be the same on both sides of the film or different from one side of the film to the other. Skin characteristics are not the result of a coating, but are surface characteristics achieved by corona treatment, impregnation of the film from one or both sides with additives such as a polycarbonate, or other techniques. Appropriate surface characteristics may be obtainable through flame treatment, ion beam modification, absorption or deposition of metaloxide metal vapors, photoisomerization or other techniques which introduce polar groups into the surface. In the present invention, the middle layer has a bottom surface 14 and a top surface 16 having slightly different characteristics. The polypropylene middle layer 12 has a bottom surface 14 with a skin adapted to promote adhesion of a styrene butadiene foam. This is accomplished by the film vendor performing corona discharge and polycarbonate impregnation steps on the film. The middle layer top surface 16 on the other hand, has a surface skin characteristic adapted to enhance printability with decorative inks. This is achieved by the film vendor using similar steps. These skin characteristics are part of commercially available polypropylene film and may be obtained by specifying desired characteristics when the film is ordered.

The sheet material 10 seen in FIG. 1 also includes a bottom foam layer 20. The bottom foam layer 20 is approximately 30 to 40 mils thick. Foams containing diene polymers or rubbers are generally preferred. One preferred material is a styrene butadiene foam. The foam is substantially uniform in thickness and in surface characteristics over its entire extent. The bottom foam layer 20 adheres directly to the polypropylene middle layer bottom surface 14. The bottom foam layer 20 has numerous small bubbles 22 of gas forming a foam. The density of the bottom foam layer 20 is approximately 6 pounds per cubic foot. The foam can vary in density from 5 pounds per cubic foot to 8 pounds per cubic foot without affecting overall performance.

Other foam materials such as neopienes, butyl rubber, polyurethane and silicone may be appropriate as the bottom foam layer 20. The foam material should be flexible, resilient, nonreactive with household surfaces, free of plasticizers, have a non-slid bottom surface and work well with the middle layer 12 selected. The bottom foam layer 20 and middle layer 12 must be compatible with respect to adhesion and non-curl characteristic of the complete sheet material 10.

A printed ink top layer 26 is adhered directly to the middle layer top surface 16. The printed ink top layer 26 can be continuous or discontinuous. The printed ink will of course be substantially thinner than illustrated in FIG. 1. Printed ink top layer 26 will, in most applications, be multicolored.

Thus, a three-component sheet material 10 is provided comprised of a of polypropylene middle layer 12, a bottom foam layer 20 adhering directly to the polypropylene 12 and a very thin printed ink top layer 26.

A second embodiment of the invention is illustrated in FIG. 2. A sheet material 11 comprises four layers rather than three layers as seen in FIG. 1. A polypropylene middle layer 13 has a printed ink top layer 26 and a primer 28 applied to the bottom surface. The polypropylene film middle layer is approximately 3 mils thick. The polypropylene film is available commercially from numerous sources including Nan Ya Plastics Corp. The printed top layer 26 is very thin and can be a multicolor ink layer which will often be continuous. The primer layer 28 is also very thin and applied in a printing process forming a continuous coating on the bottom of the polypropylene middle layer 13. A bottom foam layer 20 comprising a styrene butadiene foam adheres directly to the primer 28. The bottom foam layer 20 in the second embodiment shown in FIG. 2 is identical in all respects to the bottom foam layer described with respect to the first embodiment illustrated in FIG. 1. Of course, substitution of other appropriate materials, as described with respect to the first embodiment, is also possible.

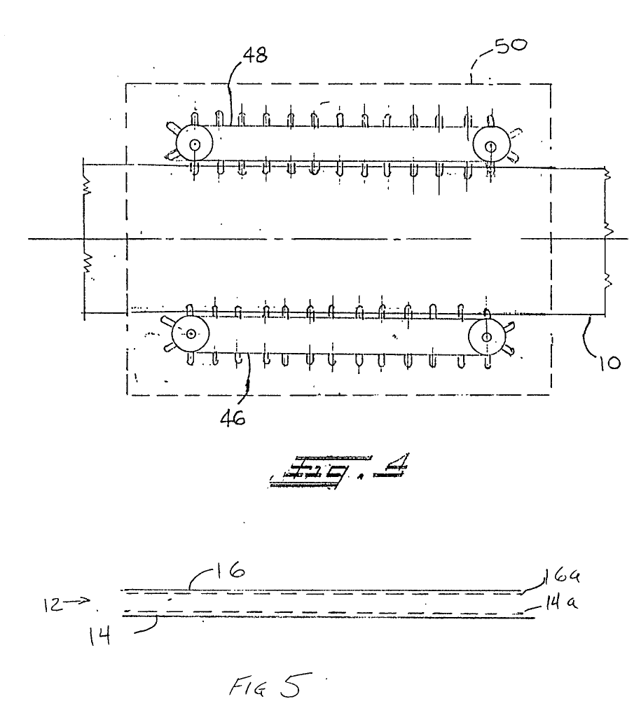

FIG. 3 schematically illustrates the method and apparatus of manufacturing the embodiments illustrated in both FIGS. 1 and 2. The process is illustrated as a continuous process but can be broken into two steps: 1) the first step including printing of the film and rewinding; and 2) the second step including casting and curing the foam layer.

A roll of polypropylene film 30 of the type desired is provided at a feed station. The film 30 is unwound such that the surface which will form the middle layer top surface 16 faces downward. Thus, the surface which will form the middle layer bottom surface 14 faces upwardly. The film 12 is fed to a gravure printer 34 where the decorative printed ink top layer 26 is applied. If a primer is needed on the bottom surface 14, it is also applied in this printing operation. The film 12 then passes through a first curing oven 36 where the ink top layer is dried and cured and the primer (if present) is also dried and cured. The film is now decorated and has an appropriate bottom surface either by means of the skin provided when the polypropylene film was made or by means of applying a primer. The stable film can be rewound for later processing or directly processed by applying foam. If the film is directly processed, the next step comprises applying an aqueous dispersion of styrene butadiene resin 42 to the upwardly facing bottom surface 14 of the film 12.

The aqueous dispersion of resin includes fillers and a blowing agent and is available from suppliers such as Foam Products Company of Calhoun, Ga. Preferably, the dispersion contains no plasticizers. The resin 42 covers the entire usable width of the film 12 and is cast to a uniform height by means of a doctor bar 44 or the like. As seen in FIG. 4, the film 12 is grasped on both edges by tentering chains 46, 48 which hold it laterally as it passes through a second curing oven 50. The heat of the second curing oven 50 activates the blowing agent in the resin 42 and cures the styrene butadiene resin 42 into a finished bottom foam layer 20 which is permanently adhered to the film 12. The finished sheet material 10 is edge trimmed as necessary and rolled on a take up roll 52.

The material on the take up roll 52 can be slit, rewound and packaged as desired at a later time.

An appropriate middle layer film 12 can also be created in a coextrusion process. A base film of polypropylene is coextruded with one or two thin surface materials. This creates a film 12 primarily consisting of polypropylene but having thin surface layers of a different, compatible material on one or both sides. The film is created in a blown extrusion process and has physical characteristics largely dictated by the base polypropylene and surface characteristics determined by the coextrusion surface materials. Because the film is made by coextrusion, a unitary integral film results. However, one may manipulate surface characteristics independently of film physical characteristics. Appropriate films are available from Blako, Industries, 10850 Middletown Pike, Dunbridge, Ohio 40414.

FIG. 5 shows, schematically, a film 12 as used in the sheet material of FIGS. 1 and 2. The film 12 has a bottom surface 14 and a top surface 16. A dashed line 14a schematically separates a very thin top surface zone from the main body of the film 12. Similarly, a dashed line 16a schematically separates a very thin bottom surface zone from the main body of the film 12. If the film 12 is created by coextrusion, the bottom and top surface zones are created by coextruding different but compatible plastics with the polypropylene to create an integral film. The boundaries between the surface zones and the main body are indistinct because the film is unitary. If the film 16 is created by corona surface treatment and polycarbonate impregnation, the boundaries between the surface zones and the main body are indistinct because the intensity of corona effect and impregnant concentration declines continuously with depth into the film.

The above-described products and process use only two major manufacturing steps and arrive at a finished sheet material comprising only two layers where previous products included three. A more uniform economical and attractive product results.

The invention has been described with reference to preferred embodiments. Obviously, modifications and alterations will occur to others upon the reading and understanding of this specification and it is intended to include such modifications and alterations which come within the scope of the appended claims or the equivalents thereof.

Having thus described the invention, it is so claimed:

1. A non-slip, non-adhesive sheet material for covering household surfaces comprising:
a thin, continuous, plastic top film, and,
a continuous foam layer of uniform thickness adhering to said film.

2. The sheet material of claim 1 wherein said top film is a film having skin characteristics on the surface of said film to which said foam layer adheres, said skin characteristics enhancing adhesion of said foam layer.

3. The sheet material of claim 2 wherein said foam layer is resilient and flexible; and, said sheet material doe snot curl when laid flat.

4. The sheet material of claim 3 wherein said plastic top film is polyolefin film.

5. The sheet material of claim 4 wherein said foam layer contains dienepolymers.

6. The sheet material of claim 4 wherein said foam layer contains rubbers.

7. The sheet material of claim 3 wherein said top film is a polyolefin film.

8. The sheet material of claim 8 wherein said top film is a polypropylene film.

9. The sheet material of claim 3 wherein said foam layer is non-reactive and free of plasticizers.

10. The sheet material of claim 3 wherein said foam layer is styrene butadiene foam.

11. The sheet material of claim 2 wherein said foam layer is about 30-40 mils thick.

12. The sheet material of claim 11 wherein said foam layer is a styrene butadiene foam.

13. The sheet material of claim 12 wherein said foam layer is free of plasticizers.

14. The sheet material of claim 13 wherein said top film is about 3 mils thick.

15. The sheet material of claim 1 wherein said top film is coated with a primer and said foam layer adheres to said primer.

16. A method of making a resilient, non-slip, non-adhesive sheet material suitable for covering household surfaces comprising the following steps:
providing a thin continuous plastic film having a top side and a bottom side;
applying a primer to said film bottom side;
providing an aqueous polymer dispersion liquid form;
applying said aqueous polymer dispersion to said primer covered bottom side of said plastic film to a uniform thickness; and,
causing said aqueous polymer dispersion to foam and cure.

17. The method of claim 16 wherein said aqueous polymer dispersion contains diene polymers.

18. The method of claim 16 wherein said aqueous polymer dispersion is a styrene butadiene polymer dispersion.

19. The method of claim 18 wherein said dispersion is free of plasticizers.

20. The method of claim 19 wherein said dispersion is caused to foam and cure in a curing oven.

21. The method of claim 20 wherein said film is secured laterally while said dispersion is cured.

22. The method of claim 16 wherein said primer is applied to said film by gravure printing.

23. The method of claim 16 wherein said film is about 3 mils thick and said cured foam is about 30-40 mils thick.

24. The method of claim 16 wherein said film is polypropylene.

25. The method of claim 16 wherein said primer is applied to said film bottom side and at least one decorative ink is applied to said film top side in a gravure printing process.

26. A method of making a non-slip, non-adhesive sheet material suitable for covering household surfaces comprising the following steps:
providing a thin continuous plastic film having a top side adapted to receive printing ink and a bottom side with skin characteristics adapted to receive a foam polymer material;
providing an aqueous polymer dispersion in a liquid form;
applying said dispersion to said film bottom side to a uniform thickness;
causing said aqueous polymer dispersion to foam and cure to a uniform height forming a cured polymer foam layer adhering directly to said film bottom side.

27. The method of claim 26 wherein said plastic film is a coextruded polypropylene film.

28. The method of claim 27 wherein said film is about 3 mils thick.

29. The method of claim 27 wherein said aqueous polymer dispersion is a styrene butadiene dispersion containing no plasticizers.

30. The method of claim 29 wherein said cured foam layer is about 30-40 mils thick.

31. The method of claim 25 wherein said polymer dispersion is cured and caused to adhere to said film by heat in a curing oven.
